(19) United States
(12) Patent Application Publication
(10) Pub. No.: US 2005/0185423 A1
(43) Pub. Date: Aug. 25, 2005

(54) Backlight system

(75) Inventors: Junji Miyashita, Fujiyoshida-shi (JP); Kiyokazu Watanabe, Minamitsuru-gun (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., Ltd., Fujiyoshida-shi (JP)

(21) Appl. No.: 11/062,461

(22) Filed: Feb. 22, 2005

(30) Foreign Application Priority Data
Feb. 20, 2004 (JP) 2004-45515

(51) Int. Cl. F21V 7/04

(52) U.S. Cl. 362/620

(57) ABSTRACT

A backlight system comprising a light-guiding plate having a light-entrance surface, an upper surface, and a lower surface, a light source disposed to face the light-entrance surface, a reflecting sheet disposed to face the lower surface of the light-guiding plate, a prismatic sheet disposed to face the upper surface of the light-guiding plate, and a micro-prismatic mechanism provided on the lower surface of the prismatic sheet, the micro-prismatic mechanism including a plurality of projection-like prismatic parts extending parallel to the light-entrance surface of the light-guiding plate and disposed at intervals in a generally perpendicular direction to the light-entrance surface, each prismatic part having a pair of prismatic surfaces, of each pair of prismatic surfaces, at least the prismatic surface on the side further from the light source forming into a curved surface.

### CROSS-REFERENCE TO THE RELATED APPLICATION

The application claims the priority benefit of Japanese Patent Application No. 2004-45515, filed on Feb. 20, 2004, the entire descriptions of which are incorporated herein by reference.

### BACKGROUND OF THE INVENTION

1. Field of the Invention

The present invention relates to a backlight system to illuminate a compact liquid crystal display from a back surface thereof, which is used in a mobile phone, a personal digital assistance (PDA) and the like.

2. Description of Related Art

Recently, cost reduction, high-brightness, a wide viewing angle, a low-profile design, weight saving, low electric power consumption, and the like have become strict requirements for backlight systems to illuminate the compact liquid crystal displays used in mobiles, PDAs and the like.

A light emitting diode (LED) having low electric power consumption and a low heat release value has been used as the light source of the backlight system. Light emitted from the LED first enters a side surface of a light-guiding plate and is transmitted while undergoing repeated reflection in the light-guiding plate. Light emitted from a lower surface of the light-guiding plate to the outside is reflected by a reflecting sheet and is returned inside the light-guiding plate. In the light-guiding plate, the light is reflected by convex shapes or saw tooth-like shapes provided on the lower surface of the light-guiding plate, and the light is finally emitted from an upper surface of the light-guiding plate. The direction of light emitted from the upper surface of the light-guiding plate is changed by a prismatic sheet, and the light illuminates an LCD from a back surface thereof (for reference, see JPA2003-59321, FIG. 1, and paragraphs 0012 to 0016).

Such a conventional backlight system includes a light-guiding plate 1, a light source 2 disposed close to a light-entrance surface 1a which is a side surface of the light-guiding plate 1, and a prismatic sheet 3 disposed on an upper surface 1b of the light-guiding plate 1. The prismatic sheet 3 has a prismatic part provided on a surface facing the upper surface 1b of the light-guiding plate 1. The prismatic part includes a plurality of projections 4, each of which has a triangular shape in section; each projection has a pair of prismatic surfaces 5a and 5b. Each of the prismatic surfaces 5a and 5b is formed in a flat surface and extends in a Y direction along the light-entrance surface 1a of the light-guiding plate 1, or the width direction of the backlight system, and the plurality of projections 4 are disposed at intervals in a Z direction perpendicular to the Y direction or the length direction of the backlight system.

However, in that kind of conventional backlight system, if the prismatic sheet 3 including the pair of prismatic surfaces 5a and 5b comprising two flat surfaces is used, because the prismatic sheet 3 has the only function of changing the direction of travel of the light, the directivity of light in the backlight system depends greatly on the directivity of the light emitted from the light-guiding plate 1 only. Accordingly, as shown in FIGS. 9 and 10, the directivity of light in the backlight system narrows in the Z direction and widens in the X direction. The light emitted from the upper surface 1b of the light-guiding plate 1 leans in the length direction as shown in FIGS. 7 and 8, so that the scope of light widens in the width direction and narrows in the length direction to become unbalanced. The differences in brightness in an LCD which uses a backlight system having a difference in the directivities of light between its length and width directions causes a feeling of discomfort and this has been a problem.

### SUMMARY OF THE INVENTION

Therefore, an object of the present invention is to resolve the above-mentioned problems and to provide a backlight system capable of equalizing the directivities of light in the length and width directions of the backlight system.

The present invention comprises a light-guiding plate having a light-entrance surface, an upper surface, and a lower surface, a light source disposed to face the light-entrance surface of the light-guiding plate, a reflecting sheet disposed to face the lower surface of the light-guiding plate, a prismatic sheet disposed to face the upper surface of the light-guiding plate, and a micro-prismatic mechanism provided on the lower surface of the prismatic sheet.

The micro-prismatic mechanism of the prismatic sheet includes a plurality of projection-like prismatic parts, and each of the prismatic part extends parallel to the light-entrance surface of the light-guiding plate and disposed at intervals in a generally perpendicular direction to the light-entrance surface. Each projection of the prismatic sheet has a pair of prismatic surfaces, and, of the pair of prismatic surfaces, at least the prismatic surface on the side which is furthest from the light source forms into a curved surface.

### BRIEF DESCRIPTION OF THE DRAWINGS

FIG. 1A is a plan view of an embodiment of a backlight system according to the present invention.

FIG. 1B is a side view of the backlight system.

FIG. 2 is a view showing the tracking of a beam in a prismatic sheet used in an embodiment of a backlight system according to the present invention.

FIG. 3 is a view of the distribution of brightness at a section in a length direction of a backlight system according to the present invention, showing directivity of light in a light-guiding plate of the backlight system.

FIG. 4 is a view of the distribution of brightness at a section in a width direction of a backlight system according to the present invention, showing directivity of light in the light-guiding plate of the backlight system.

FIG. 5 is a view showing the tracking of a beam in the light-guiding plate of the backlight system according to the present invention.

FIG. 6 is a view showing the tracking of a beam in a prismatic sheet of a conventional backlight system.

FIG. 7 is a view of the distribution of brightness at a section in a length direction of the backlight system, showing directivity of a conventional light-guiding plate.

FIG. 8 is a view of the distribution of brightness at a section in a width direction of the backlight system, showing directivity of the conventional light-guiding plate.

FIG. 9 is a view of the distribution of brightness at a section in a length direction of the backlight system, showing directivity of the conventional backlight system.

FIG. 10 is a view of the distribution of brightness at a section in a width direction of the backlight system, showing directivity of the conventional backlight system.

### DETAILED DESCRIPTION OF THE PREFERRED EMBODIMENTS

Preferred embodiments of the present invention will be explained with reference to the accompanying drawings below.

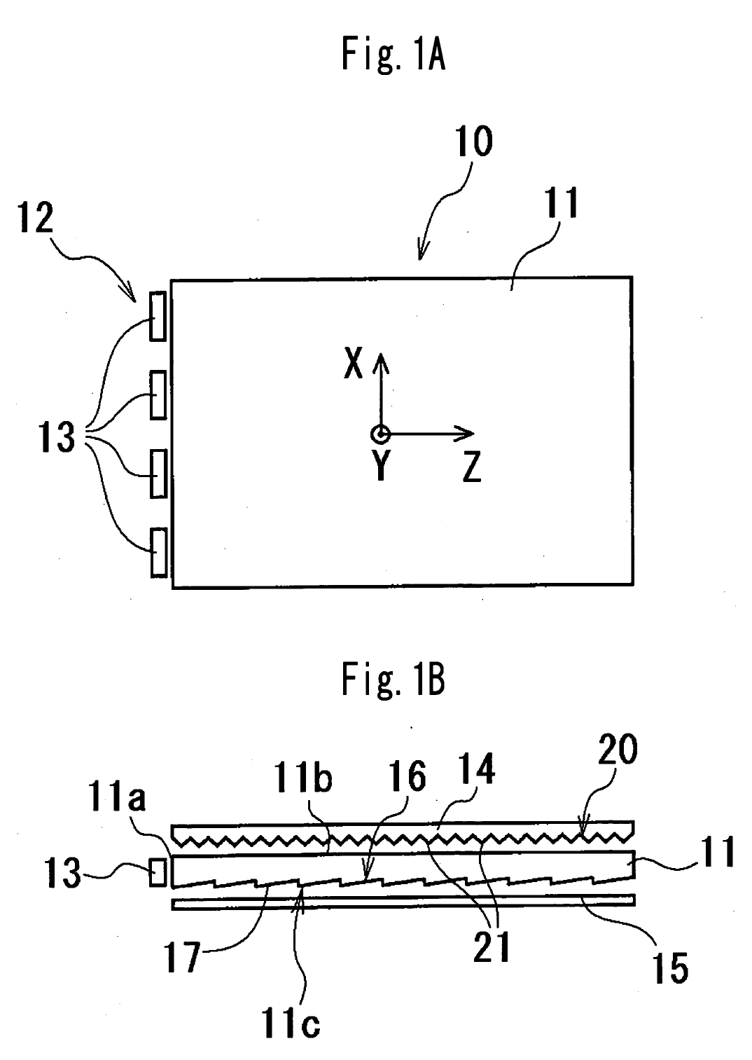

Referring to FIGS. 1A and 1B, a backlight system 10 in an embodiment of the present invention is shown. The backlight system 10 comprises a light-guiding plate 11 and a light source 12 to irradiate light to the light-guiding plate 11. The light source 12 comprises a plurality of light emitting diodes (LEDs) 13 in the shown embodiment, the LEDs 13 are disposed to face a light-entrance surface Ha formed on a side surface of the light-guiding plate 11 and arranged at intervals along the light-entrance surface 11a.

A prismatic sheet 14 is also disposed to face an upper surface 11b of the light-guiding plate 11 and adjacent to the upper surface 11b, and a reflecting sheet 15 is further disposed to face a lower surface 11c of the light-guiding plate 11 and adjacent to the lower surface 11c. Whether the prismatic sheet is disposed close to the upper surface 11b or disposed touching the upper surface 11b is in the scope of the present invention and does not change the effect according to the present invention.

Meanwhile, in FIG. 1A, character X denotes the width direction of the backlight system 10, which corresponds to the direction in which the LEDs 13 are arranged, in other words, the direction along the light-entrance surface 11a of the light-guiding plate 11, character Y denotes the irradiation direction of the backlight system 10, in other words, the direction perpendicular to the upper surface 11b of the light-guiding plate 11, and character Z denotes the length direction of the backlight system 10 perpendicular to the X direction.

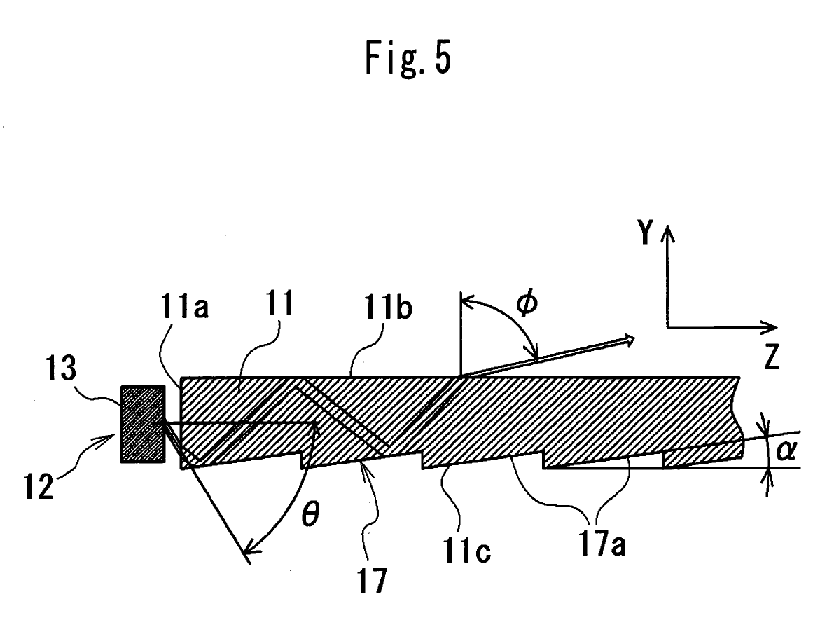

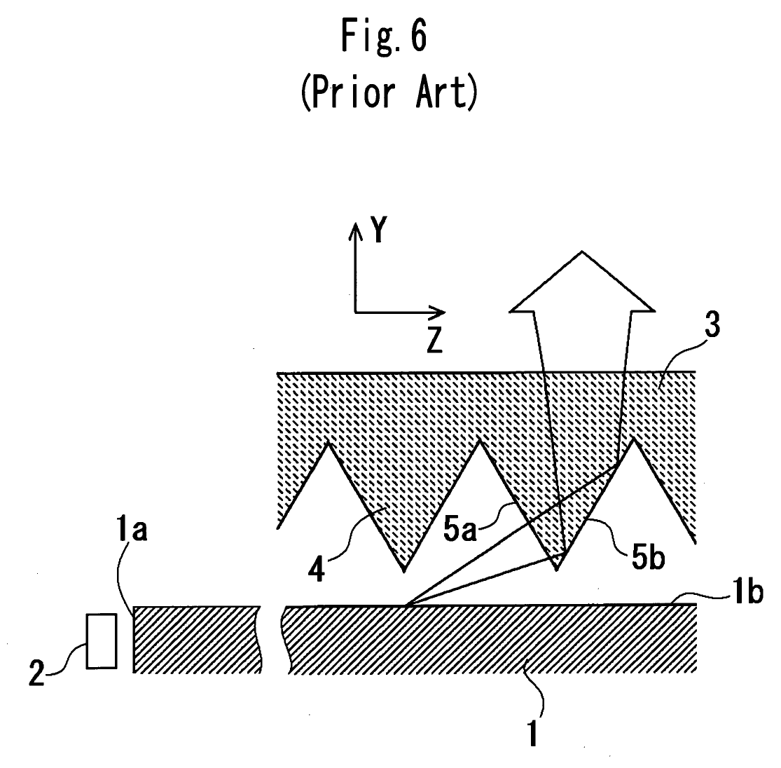

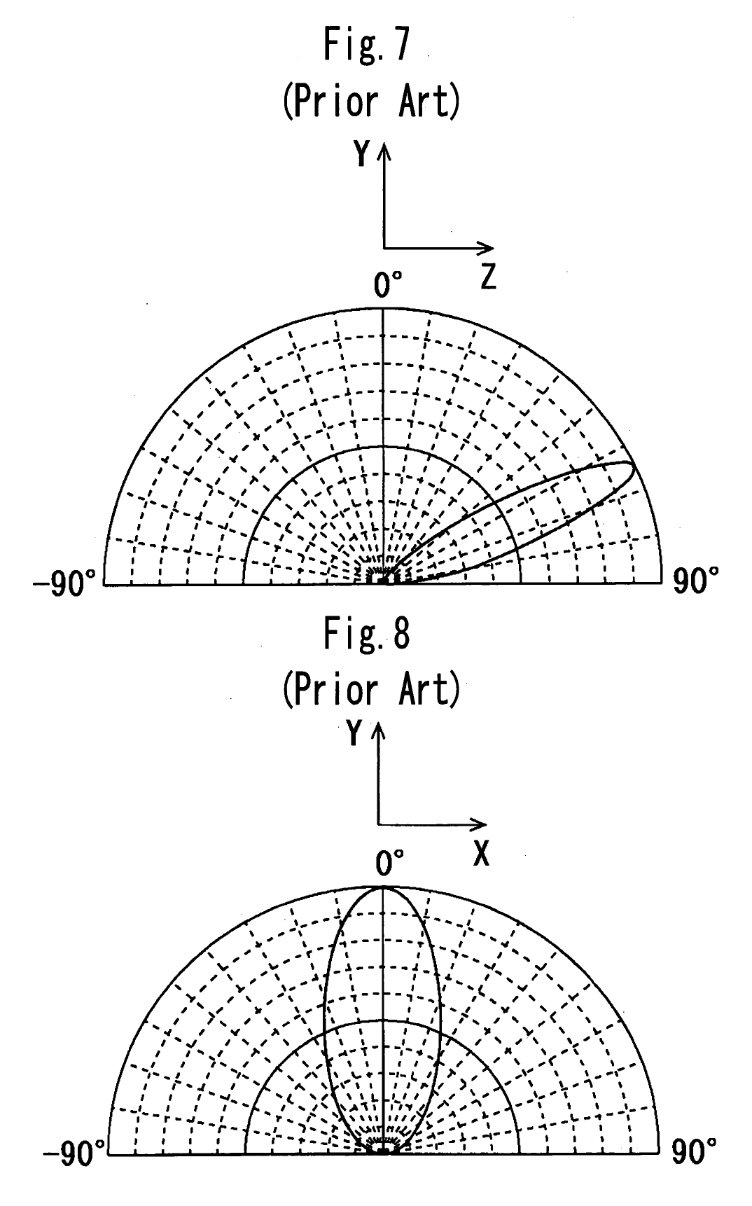

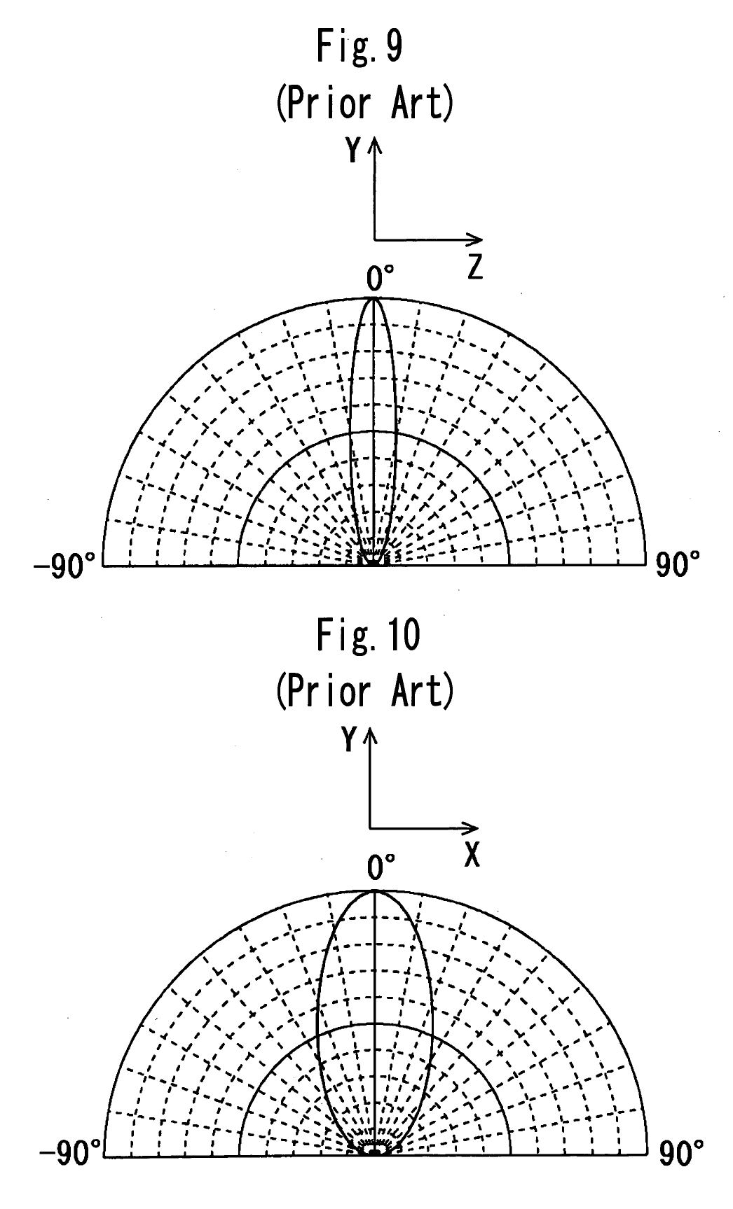

A prism 16 is provided on the lower surface 11c of the light-guiding plate 11. The prism 16 comprises a plurality of steps 17 disposed at intervals in the length direction of the backlight system 10, or the Z direction. Each of the plurality of steps 17 extends in the width direction of the backlight system 10, or the X direction. More specifically, each step 17 has an inclined surface 17a having an angle α, as shown in FIG. 5. The angle α is set to efficiently direct light from the light source 12 to the upper surface 11b of the light-guiding plate 11.

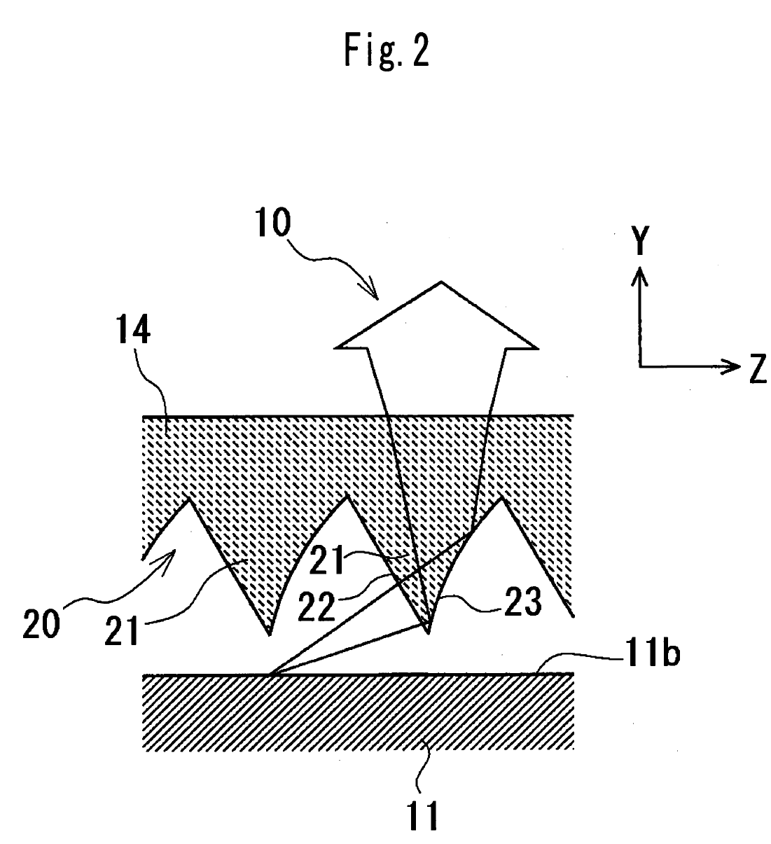

The prismatic sheet 14 includes a micro-prismatic mechanism 20 provided on a surface facing the upper surface 11b of the light-guiding plate 11, as shown in FIG. 2. The micro-prismatic mechanism 20, of the prismatic sheet 14 comprises a plurality of projection-like prismatic parts 21, which are disposed at intervals in the length direction of the backlight system 10, in other words, the Z direction, in the shown embodiment. Each of the plurality of projection-like prismatic parts 21 extends parallel with the width direction of the backlight system 10, or the X direction. Each of the plurality of projection-like prismatic parts 21 has a generally triangular shape, and each prismatic part 21 has a pair of prismatic surfaces 22 and 23 extending in the direction along the light-entrance surface 11a of the light-guiding plate or the X direction.

Of the pair of prismatic surfaces 22 and 23, the prismatic surface 22 on the side closer to the light source 12 is formed in a flat surface and the prismatic surface 23 on the side further from the light source 12 is formed in a curved surface. For example, the curved surface of the prismatic surface 23 curves convexly toward the light source 12.

Next, the operation of the above-mentioned backlight system 10 is described.

As shown in FIG. 5, the light emitted from the LEDs 13 in the Z direction, slightly downwardly, at an angle θ enters the inside of the light-guiding plate 11 through the light-entrance surface 11a.

In the light-guiding plate 11, when the light strikes the lower surface 11c at an incident angle which is the critical angle or exceeds the critical angle, the light is reflected totally on the lower surface 11c and is directed to the upper surface 11b. When the light reflected from the lower surface strikes the upper surface 11b at an incident angle which is the critical angle or more, the light is reflected totally on the upper surface 11b and is directed to the lower surface 11c again. The light is repeatedly reflected on the upper and lower surfaces 11b and 11c, but the light is emitted upwardly from the upper surface 11b at an exit angle φ as a result of the inclined surface 17a of each of the steps 17 if the incident angle is less than the critical angle. The light emitted from the lower surface 11c to the outside is returned to the inside of the light-guiding plate 11 by the reflecting sheet 15.

As shown in FIG. 2, the light emitted from the light-guiding plate 11 in the Z direction passes through the prismatic surface 22 of the prismatic sheet 14, is reflected on the prismatic surface 23, has its direction of travel changed to an upward direction, and is emitted from an upper surface of the prismatic sheet 14 toward a back surface of an LCD (not shown).

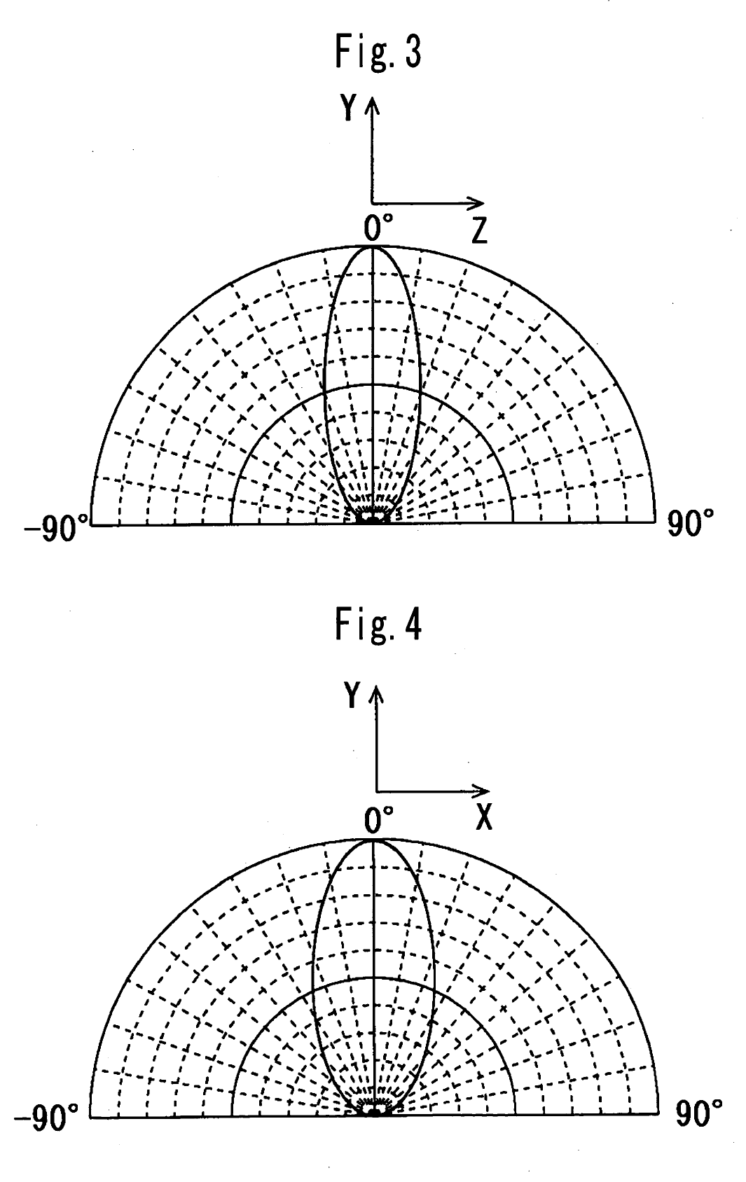

In this case, most of the light emitted from the light-guiding plate 11 enters the prismatic surface 22 of the prismatic sheet 14 without reflection because the prismatic surface 22 is flat. Moreover, the broadening of the light in the Z direction further increases when being reflected because the prismatic surface 23 is concave, hence the scope of the light in the direction of travel is expandable. Accordingly, it is possible to equalize the directivities of the length-width directions of the light emitted from the backlight system 10, as shown in FIGS. 3 and 4, hence a backlight system or illumination device of high quality which achieving causes no feeling of discomfort to the person viewing the display.

Tracing the light emitted from the light-guiding plate 11, as shown in FIG. 2, shows that it enters the prismatic surface 22 of the prismatic sheet 14, that the broadening thereof in the Z direction increases when the light entering is reflected on the concave prismatic surface 23, and that it directed in the illuminating direction or the Y direction.

According to the present invention, because it is provided with a micro-prismatic mechanism having a pair of prismatic surfaces provided on the lower surface of the prismatic sheet, and, of the pair of prismatic surfaces, the prismatic surface on the side further from the light source is formed in a curved surface, the scope of light in the traveling direction is spread, therefore the directivity in the length direction of the backlight system can be widened. Accordingly, because it is possible to equalize the directivities of the light emitted from the backlight system in the length and width directions of the backlight system, a backlight system with a high quality of illumination which causes no feeling of discomfort to the person viewing the LCD can be produced.

Furthermore, the backlight system according to the present invention can be applied to the illumination of LCDs in compact electronic devices such as mobile phones, PDAs and the like.

Although the preferred embodiments of the present invention have been described, the present invention is not limited to these embodiments; it should be noted that various modifications and changes can be made for these embodiments.

1. A backlight system comprising:
a light-guiding plate having a light-entrance surface, an upper surface, and a lower surface;
a light source disposed to face the light-entrance surface;
a reflecting sheet disposed to face the lower surface of the light-guiding plate;
a prismatic sheet disposed to face the upper surface of the light-guiding plate; and
a micro-prismatic mechanism provided on the lower surface of the prismatic sheet,
the micro-prismatic mechanism including a plurality of projection-like prismatic parts extending parallel to the light-entrance surface of the light-guiding plate and disposed at intervals. in a generally perpendicular direction to the light-entrance surface,
each of the prismatic parts having a pair of prismatic surfaces,
of each pair of prismatic surfaces, at least the prismatic surface on the side furthest from the light source forming into a curved surface.

2. The backlight system according to claim 1,
wherein the curved surface of each prismatic part curves convexly toward the light source.

3. The backlight system according to claim 1,
wherein, of each pair of prismatic surfaces, the prismatic surface closer to the light source forms into a flat surface.
